(19) United States
(12) Patent Application Publication
(10) Pub. No.: US 2014/0321137 A1
(43) Pub. Date: Oct. 30, 2014

(54) VEHICLE HEADLAMP

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 14/054,808

(22) Filed: Oct. 15, 2013

(30) Foreign Application Priority Data
Apr. 26, 2013 (TW) 102114935

(51) Int. Cl. F21S 8/10; F21V 8/00

(52) U.S. Cl. CPC F21S 48/125; G02B 6/003; F21S 48/1241
USPC 362/511

(57) ABSTRACT

A vehicle headlamp includes an LED light source, a light guide plate optically coupled to the LED light source, and a convergent lens positioned therebetween to converge light from the LED light source to an optical fiber bundle which is connected with the light guide plate. The light guide plate includes a light incident face for receiving light exiting from the convergent lens, a light exit face, a bottom face adjacent to the light incident face for reflecting light toward the light exit face thereof, and at least a bent surface extending between the bottom face and the light exit face. The vehicle headlamp creates a specific illumination field with a desired bright/dark cut-off line as the light from the LED light source passes through the convergent lens and the light guide plate in succession to project out of the vehicle headlamp.

### TECHNICAL FIELD

The present disclosure relates generally to a vehicle headlamp, and particularly to an LED headlamp for a vehicle wherein the LED headlamp has an improved light utilization efficiency and heat dissipation efficiency.

### DESCRIPTION OF RELATED ART

LEDs are solid state light emitting devices formed of semiconductors, which are more stable and reliable than other conventional light sources such as incandescent bulbs. Thus, LEDs are being widely used in various fields such as numeral/character displaying elements, signal lights, light sources for lighting and display devices.

Nowadays, light emitting diode (LED) light sources are widely applied for illumination, such as being used for vehicle illumination. A traditional vehicle headlamp includes an LED light source, a reflector for reflecting light from the LED light source toward a projection lens, and a light shielding sheet placed between the LED light source and the projection lens for creating a specific irradiation region with a desired bright/dark cut-off line to satisfy certain traffic regulations. However, the light shielding sheet prevents a portion of light emitted from the LED light source, thereby decreasing the light utilization efficiency of the vehicle headlamp. Therefore, such a vehicle headlamp is difficult to satisfy the requirements of high light utilization efficiency. Furthermore, the heat generated by the LED light source is difficult to be dissipated, which disadvantageously affects the quality and lifespan of the vehicle headlamp.

What is needed therefore is a vehicle headlamp having an LED light source which can overcome the above mentioned limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a schematic view of a vehicle headlamp in accordance with a first embodiment of the present disclosure.

FIG. 2 is a side view of a reflecting sheet and a light guide plate of the vehicle headlamp of FIG. 1, together with a pair of prism sheets and a projection lens.

FIG. 3 is a convergent lens of the vehicle headlamp in accordance with a second embodiment of the present disclosure.

### DETAILED DESCRIPTION

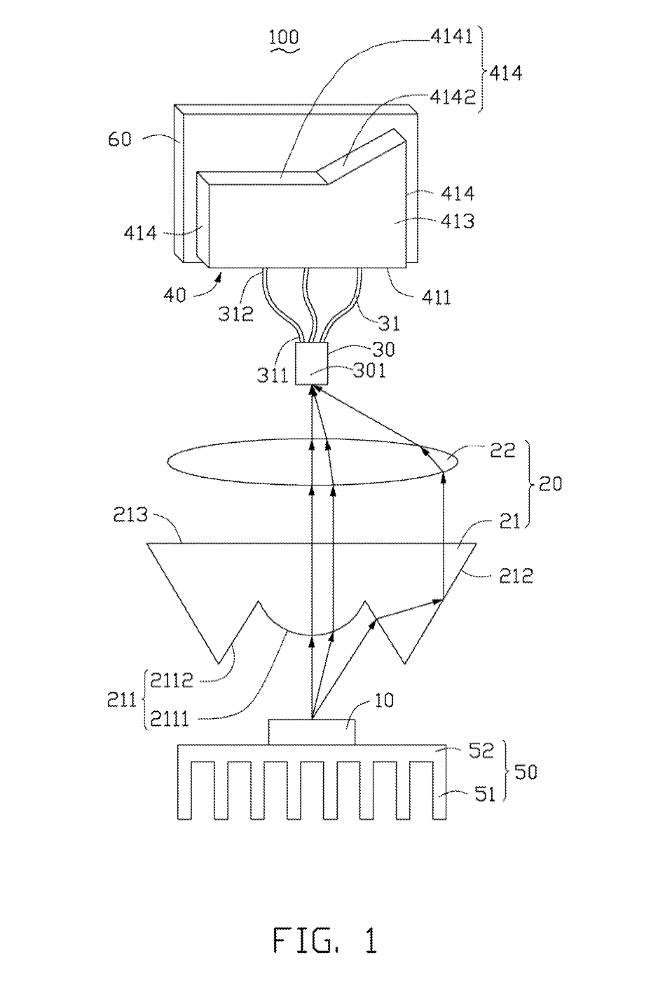

Referring to FIG. 1, a vehicle headlamp 100 in accordance with a first embodiment of the present disclosure includes an LED light source 10, a convergent lens 20, a light guide plate 40, and an optical fiber bundle 30 positioned between the convergent lens 20 and the light guide plate 40.

The LED light source 10 is mounted on a top face of a heat sink 50. The heat sink 50 is provided for dissipating heat generated from the LED light source 10. The heat sink 50 includes a base 52 and a plurality of fins 51 extending downwardly from a bottom face of the base 52 opposite to the top face thereof.

The convergent lens 20 is positioned between the LED light source 10 and the optical fiber bundle 30 to converge light emitted from the LED light source 10 and direct the light into the optical fiber bundle 30. The convergent lens 20 includes a collimating lens 21 and a focus lens 22.

The collimating lens 21 of the convergent lens 20 includes a light incident face 211, a light exit face 213, and a conical surface 212 interconnecting the light incident face 211 and the light exit face 213. The conical surface 212 has a diameter increasing gradually from the light incident face 211 toward the light exit face 123. The light exit face 213 of the collimating lens 21 is a flat surface. The light emitted from the LED light source 10 enters the collimating lens 21 through the light incident face 211, and a portion of light refracted at a large angle is projected onto the conical surface 212 and then reflected by the conical surface 212 toward the light exit face 213.

The light incident face 211 of the collimating lens 21 is recessed inwardly from a lower edge of the conical surface 212 toward an interior of the collimating lens 21. The light incident face 211 includes a first light incident face 2111 and a second incident face 2112 surrounding the first light incident face 2111. The first light incident face 2111 is an arced face and protrudes outwardly toward the LED light source 10. The second light incident face 2112 is conical. The second light incident face 2112 has a diameter decreasing gradually from the lower edge of the conical surface 212 of the collimating lens 21 toward the arced first light incident face 2111.

The focus lens 22 is a convex lens, such as a biconvex lens. The parallel light beams exiting from the collimating lens 21 are focused by the focus lens 22 into a light collector/splitter 301 of the optical fiber bundle 30, which collects the light beams and evenly divides the collected light beams into a plurality of equal parts of light.

The optical fiber bundle 30 is configured for coupling the light from the focus lens 22 of the convergent lens 20 into the light guide plate 40. The optical fiber bundle 30 includes a plurality of optical fibers 31 with an input terminal 311 of each optical fiber 31 bundled together and connected to the light collector/splitter 301 and an output terminal 312 of each optical fiber 31 spread apart. The light collector/splitter 301 is positioned at or near a focal point of the focus lens 22 of the convergent lens 20. The equal parts of light split by the collector/splitter 301 are directed into a corresponding optical fiber 31.

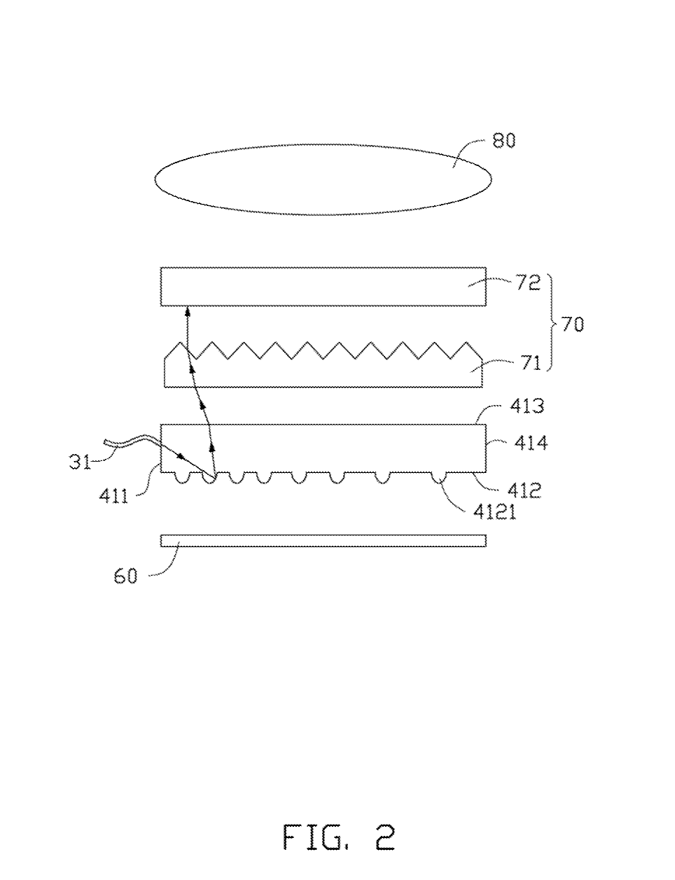

Referring to FIGS. 1 and 2, the light guide plate 40 includes a light incident face 411, a bottom face 412, a light exit face 413, and three lateral faces 414 extending between the bottom face 412 and the light exit face 413. The three lateral faces 414 are connected to each other end-to-end. The lateral face 414 opposite to the light incident face 411 is a bent surface. The bent surface 414 includes a horizontal surface 4141 and an inclined surface 4142 connected to the flat surface 4141. The bent surface 414 and the remaining lateral faces 414 are reflective and cooperatively confine the light within the light guide plate 40, without leaving the light guide plate 40 via the three lateral faces 414. The bottom face 412 is also reflective. The light inside the light guide plate 40 is reflected by the bottom face 412 toward the light exit face 413 of the light guide plate 40.

The bottom face 412 of the light guide plate 40 defines a plurality of micro dot patterns 4121 to scatter and reflect the light incident on the bottom face 412 toward the light exit face 413 of the light guide plate 40. In order to improve the light utilization efficiency, a reflective sheet 60 is disposed beneath the bottom face 412 of the light guide plate 40 to reflect light exiting from the bottom face 412 back toward the light guide plate 40.

The vehicle headlamp 100 further includes a pair of prism sheets 70, i.e., a first prism sheet 71 and a second prism sheet 72 located above the light exit face 413 of the light guide plate 40. Prisms on the first prism sheet 71 are oriented to be perpendicular to the orientation of prisms on the second prism lens 72. The pair of prism sheets 70 are configured for converging light exiting from the light guide plate 40 along a first direction and a second direction perpendicular to the first direction in succession. The light transmitting through the pair of prism sheets 70 is projected out from the vehicle headlamp 100 by a projection lens 80 located above the pair of prism sheets 70.

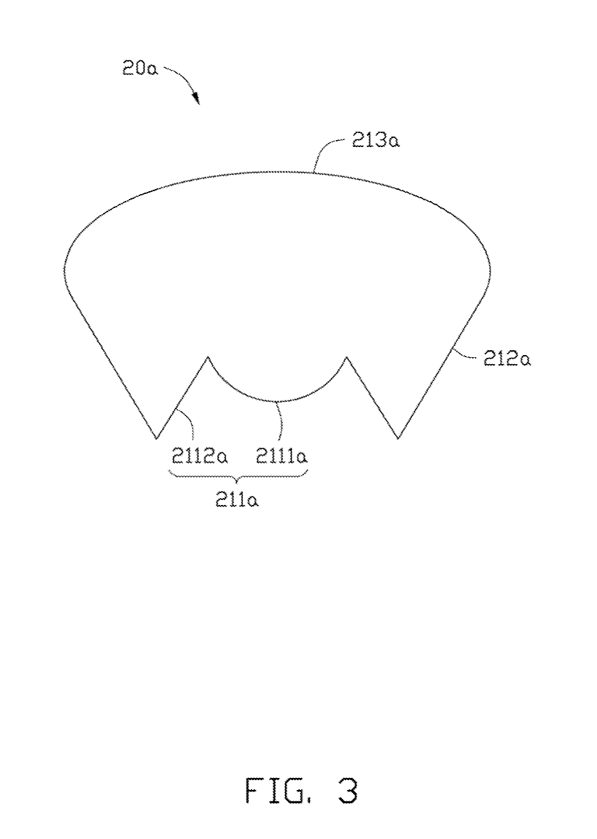

Referring to FIG. 3, different from the convergent lens 20 of the vehicle headlamp 100 shown in FIG. 1, a convergent lens 20a of the vehicle headlamp in accordance with a second embodiment is a single piece component. The convergent lens 20a includes a light incident face 211a, a light exit face 213a, and a conical surface 212a interconnecting the light incident face 211a and the light exit face 213a.

The conical surface 212a of the convergent lens 20a has a diameter increasing gradually from the light incident face 211a toward the light exit face 213a. The light exit face 213a is a convex face. The light incident face 211a is recessed inwardly from a lower edge of the conical surface 212a toward an interior of the convergent lens 20a. The light incident face 211a includes a first light incident face 2111a and a second light incident face 2112a surrounding the first light incident face 2111a. The first light incident face 2111a is an arced face and protrudes outwardly toward the LED light source. The second light incident face 2112a is conical and has a diameter decreasing gradually from the lower edge of the conical surface 212a of the convergent lens 20a toward the arced first light incident face 2111a.

In the present disclosure, the bent surface 414 is located opposite the light incident face 411 and defines a part of a periphery of the light exit face 413 of the light guide plate 40. The bent surface 414 and the remaining lateral faces 414 cooperatively confine the light within the light guide plate 40. The light inside the light guide plate 40 is reflected by the bottom face 412 toward the light exit face 413 of the light guide plate 40. The vehicle headlamp 100 creates a specific illumination field with a desired bright/dark cut-off line as light emitted from the LED light source 10 transmits through the convergent lens 20, 20a, the light guide plate 40 and the projection lens 80 in succession. Thus, the vehicle headlamp 100 having high light utilization efficiency is obtained. Furthermore, by the provision of the heat sink 50 which can effectively absorb heat from the LED light source 10 and the optical fiber bundle 30 which enables the LED light source 10 to be placed at a position under the hood of a car away from the heat source, i.e., the engine; the heat generated by the LED light source 10 can be effectively dissipated accordingly, whereby the LED light source 10 of the vehicle headlamp 100 can have a stable performance and an extended lifespan.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A vehicle headlamp comprising:
an LED light source;
a light guide plate optically coupled to the LED light source; and
a convergent lens positioned between the LED light source and the light guide plate to converge light emitted from the LED light source and direct the light into the light guide plate;
wherein the light guide plate comprises a light incident face for receiving the light exiting from the convergent lens, a light exit face, a bottom face adjacent to the light incident face for reflecting the light toward the light exit face, and at least a bent surface extending between the bottom face and the light exit face for creating a specific illumination field with a desired bright/dark cut-off line for the light emitted from the vehicle headlamp.

2. The vehicle headlamp of claim 1, wherein the convergent lens comprises a light incident face, a light exit face, and a conical surface interconnecting the light incident face and the light exit face.

3. The vehicle headlamp of claim 2, wherein the conical surface of the convergent lens has a diameter increasing gradually from the light incident face toward the light exit face of the convergent lens.

4. The vehicle headlamp of claim 3, wherein the light exit face of the convergent lens is a convex face, and the light incident face of the convergent lens is recessed inwardly from a lower edge of the conical surface toward an interior of the convergent lens.

5. The vehicle headlamp of claim 4, wherein the light incident face of the convergent lens comprises a first light incident face and a second light incident face surrounding the first light incident face, and the first light incident face of the convergent lens protrudes outwardly toward the LED light source.

6. The vehicle headlamp of claim 5, wherein the second light incident face of the convergent lens is conical, and the second light incident face has a diameter decreasing gradually from the lower edge of the conical surface toward the first light incident face.

7. The vehicle headlamp of claim 1, wherein the convergent lens comprises a collimating lens and a focus lens.

8. The vehicle headlamp of claim 7, wherein the collimating lens of the convergent lens comprises a light incident face, a light exit face, and a conical surface interconnecting the light incident face and the light exit face.

9. The vehicle headlamp of claim 8, wherein the conical surface of the collimating lens has a diameter increasing gradually from the light incident face toward the light exit face of the collimating lens.

10. The vehicle headlamp of claim 9, wherein the light exit face of the collimating lens is flat, and the light incident face of the collimating lens is recessed inwardly from a lower edge of the conical surface toward an interior of the collimating lens.

11. The vehicle headlamp of claim 10, wherein the light incident face of the collimating lens comprises a first light incident face and a second light incident face surrounding the first light incident face, and the first light incident face of the collimating lens is an arced face and protrudes outwardly toward the LED light source.

12. The vehicle headlamp of claim 7, wherein the focus lens is a convex lens.

13. The vehicle headlamp of claim 1, further comprising an optical fiber bundle positioned between the convergent lens and the light guide plate for optically coupling light from the convergent lens into the light guide plate.

14. The vehicle headlamp of claim 13, wherein the optical fiber bundle includes a plurality of optical fibers with an input terminal of each optical fiber bundled together and connected to a light collector/splitter and an output terminal of each optical fiber spread apart and connected to the light guide plate, and the light collector/splitter is positioned at or near a focal point of the convergent lens.

15. The vehicle headlamp of claim 1, further comprising a heat sink for dissipating heat generated from the LED light source, wherein the LED light source is mounted on a top face of the heat sink.

16. The vehicle headlamp of claim 1, wherein the bottom face of the light guide plate defines a plurality of micro dot patterns to scatter and reflect the light incident on the bottom face toward the light exit face of the light guide plate.

17. The vehicle headlamp of claim 16, further comprising a reflective sheet disposed beneath the bottom face of the light guide plate to reflect light exiting from the bottom face back toward the light guide plate.

18. The vehicle headlamp of claim 16, further comprising a first prism sheet and a second prism sheet located above the light exit face of the light guide plate, wherein prisms of the first prism sheet are oriented along a direction which is perpendicular to that of prisms of the second prism sheet.

19. The vehicle headlamp of claim 18, further comprising a projection lens located above the first prism and the second prism to project light out from the vehicle headlamp.

20. The vehicle headlamp of claim 1, wherein the bent surface is opposite to the light incident face of the light guide plate, and the bent face comprises a horizontal surface and an inclined surface connected with the horizontal surface.
